(19) United States
(12) Patent Application Publication
(10) Pub. No.: US 2005/0023479 A1
(43) Pub. Date: Feb. 3, 2005

(54) Neutron and gamma ray monitor

(75) Inventor: Lee Grodzins, Lexington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: NITON LLC, Billerica, MA (US)

(21) Appl. No.: 10/861,332

(22) Filed: Jun. 4, 2004

Related U.S. Application Data
(60) Provisional application No. 60/476,101, filed on Jun. 5, 2003.

(51) Int. Cl. G01N 23/10; G01T 3/06; G01N 23/223

(52) U.S. Cl. 250/390.11; 378/44

(57) ABSTRACT

An apparatus for selective radiation detection includes a neutron detector that facilitates detection of neutron emitters, e.g. plutonium, and the like; a gamma ray detector that facilitates detection of gamma ray sources, e.g., uranium, and the like; and/or an X-ray analyzer that facilitates detection of materials that can shield radioactive sources, e.g., lead, and the like.

### RELATED APPLICATION

This application claims the benefit of U.S. Provisional Application No. 60/476,101, filed on Jun. 5, 2003, the entire teachings of which are incorporated herein by reference.

### BACKGROUND OF THE INVENTION

With the rise of terrorism there is a growing need for effective detectors for radioactive weapons of mass destruction, or materials used to shield their radiation form detection, e.g., high atomic weight elements. Three weapons of special concern are so-called “dirty bombs”, uranium-based atomic bombs, and plutonium-based atomic bombs. For example, dirty bombs include chemical explosives surrounded by radioactive materials to be dispersed upon detonation, contaminating the surroundings. Dirty bombs can be detected by their emitted radiation, gamma and bremsstrahlung radiation being the most common signatures. Uranium-based atomic bombs can in principle be identified by the signature gamma rays of ²³⁵U or ²³⁸U. The radiation flux from weapons-grade ²³⁵U is low, and therefore excellent efficiency and good energy resolution is desirable to distinguish ²³⁵U or ²³⁸U signature gamma rays from background gamma rays and from innocent sources. Plutonium-based atomic bombs can be detected by neutron emission. Neutron emitters are sufficiently rare that the detection of a neutron source several times above neutron background levels can be prima facie evidence for the presence of plutonium.

The detection of gamma rays and neutrons has a long history dating from their discoveries. Many topical books and monographs are available, for example, “Radiation Detection and Measurement, Third Edition, 1999” by Glenn F. Knoll, Wiley Press”, the entire teachings of which are incorporated herein by reference. Until recently, radiation detectors were used almost exclusively for benign commercial or research applications. Gamma ray devices with good efficiency and energy resolution have been available since NaI(Tl); the most widely used inorganic scintillator, was introduced in the late 1940's. There are now a number of inorganic and organic scintillators, as well as a number of semiconductor detectors that are commercially available for detecting gamma rays of low and high energy in configurations adapted for a variety of applications. Light from the scintillators can be detected by an optical detector, e.g., photomultipliers, photodiodes, and charge-coupled devices (CCDs) and the like. However, these detectors cannot detect gamma ray sources shielded by a sufficient mass of a high Z material, e.g., lead, tungsten, and the like. Commercial neutron detectors also became available in the early 1960s. These relatively bulky devices detect thermal neutrons with gas-proportional counters filled with either BF₃ or ³He. High energy neutrons can typically be measured by plastic and liquid scintillators that detect the highly ionizing protons produced when the energetic neutrons collide elastically with the hydrogen nuclei. The presence of fast neutrons can also be determined by thermalizing, or moderating the speed of the neutrons with a hydrogenous material, and detecting the resulting thermal neutrons with efficient thermal neutron detectors. Plastic and liquid scintillator containing lithium or boron are examples of detectors that employ this method.

### SUMMARY OF THE INVENTION

Existing commercial radiation detectors do not meet existing radiological weapon detection needs, including selectivity, efficiency, portability, and detection of the three main types of radioactive weapons. Further, existing radiation detectors cannot detect gamma rays from a shielded weapon, for example, a weapon shielded by lead. Therefore, there is a need for effective detectors of radioactive weapons of mass destruction, including shielded weapons.

In various embodiments of the invention, an apparatus includes a neutron detector that facilitates detection of neutron emitters, e.g. plutonium, and the like; a gamma ray detector that facilitates detection of gamma ray sources, e.g., uranium, and the like; and/or an X-ray analyzer that facilitates detection of materials that can shield radioactive sources, e.g., lead, and the like.

In one embodiment, an apparatus for selective radiation detection includes a neutron scintillator, an optical detector; and a light guide that couples the neutron scintillator to the optical detector. The light guide is a liquid or solid, typically solid. In various embodiments, the neutron scintillator can respond to fast neutrons, thermal neutrons, or both.

In other embodiments, an apparatus for selective radiation detection includes an X-ray fluorescence analyzer and a neutron or gamma ray scintillator coupled to an optical detector.

In another embodiment, an apparatus for selective radiation detection includes a gamma ray scintillator and a neutron scintillator coupled to an optical detector, and an X-ray fluorescence analyzer.

In another embodiment, an apparatus for selective radiation detection includes a gamma ray scintillator and a neutron scintillator coupled to an optical detector.

In various embodiments, each preceding apparatus can be adapted for handheld use. In some embodiments, each preceding apparatus can be controlled by a controller, e.g., an electronic controller. For example, the controller can be coupled to the optical detector to selectively detect thermal neutrons, fast neutrons, and/or gamma rays; or the controller can be coupled to the X-ray fluorescence analyzer to detect X-ray fluorescence, e.g., to irradiate a target with X-rays and selectively detect X-ray fluorescence from the target.

Also included are methods of selectively detecting radiation.

The embodiments disclosed herein provide numerous advantages over conventional commercial radiation detectors, particularly in light of features desirable for detecting radiation and radiation shielding associated with weapons of mass destruction.

For example, multiple detectors for different radiation sources, e.g., a thermal neutron detector; a fast neutron detector; and/or a gamma ray detector, can be combined in a single detector. Also, such radiation detectors can be combined with an X-ray fluorescence analyzer which can detect the presence of typical radiation shielding materials.

A new neutron detector is disclosed wherein scintillation light can be directed to the optical detector by a light guide that can also function as a fast neutron scintillator and/or a fast neutron thermalizer. This new neutron detector has significant advantages compared to conventional ³He neutron detectors, including lighter weight for the same efficiency, less expensive, more selective for neutrons over gamma rays, less sensitivity to temperature, and fewer transport restrictions. Further, the detector can be made in configurations that allow detection of the direction of a neutron source with respect to the apparatus.

The provision of optically transparent materials for light guides and scintillators allows scintillation arising from two or more sources (e.g., fast neutrons, thermal neutrons, and/or gamma rays) to be directed to the same optical detector. Further, the scintillation materials employed allow an electronic controller to distinguish the different types of radiation by their scintillation signal as a function of time.

The individual radiation detectors and the X-ray fluorescence analyzer can be controlled by the same controller. In combination with other preceding features which allow lighter weight or the combination of multiple functions, various embodiments herein lead to a light weight, handheld, automated multifunction selective radiation detector.

Thus, various embodiments herein can simultaneously detect the presence of dirty bombs, uranium-based atomic bombs and plutonium-based atomic bombs, and identify and measure the radiation levels of radioactive sources, and detect materials which may be used to shield such radioactive sources from detection.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts an embodiment of selective radiation detection apparatus 10 equipped to detect gamma rays and neutrons.

FIG. 2 depicts optional X-ray fluorescence (XRF) detector 40 coupled to controller 70 for detecting high atomic weight (high Z) materials 54 that can shield radioactive materials, e.g. gamma ray source 56.

FIG. 3 depicts an embodiment of new neutron detector apparatus 120 employing a configuration of light guides 82 and thermal neutron scintillator layers 80.

FIG. 4 depicts the components of an apparatus 130 for selective detection of neutrons and gamma rays viewed by a single optical detector 26.

FIG. 5 depicts an isometric drawing of an embodiment of a new neutron scintillator/light guide apparatus 150.

FIG. 6 depicts another embodiment of neutron scintillator/light guide apparatus 168 where multiple light guide segments 160 are employed to provide the neutron detector with directional capability.

FIG. 7 depicts apparatus 700 in which neutron and gamma detectors and an -ray fluorescent analyzer are integrated with a controller into a single, compact unit adapted for handheld Homeland Security bomb detection.

### DETAILED DESCRIPTION OF THE INVENTION

A description of preferred embodiments of the invention follows.

The various embodiments herein relate to methods and an apparatus for detecting targets, e.g., signatures of radioactive weapons such as neutrons and gamma rays, and high-Z materials, e.g., lead, tungsten, and the like, that can shield gamma ray sources from detection. The various embodiments described here are examples of many configurations of a “universal”, portable, hand-held, terrorist-threat detector that can identify such targets. In various embodiments, detection is possible for one or more targets, such as: gamma rays, e.g., gamma rays characteristic of specific radioisotopes; neutrons characteristic of plutonium; and high atomic-weight (high Z) material that can shield radioactive, e.g., gamma ray sources. In some embodiments, a single handheld detector is employed to record evidence of these targets and alert the operator to their presence.

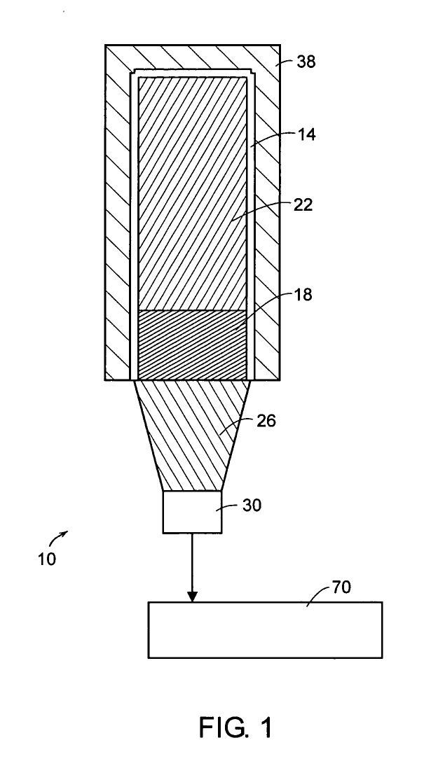

FIG. 1 depicts an embodiment of selective radiation detection apparatus 10 equipped to detect gamma rays and neutrons. Neutron scintillator 14 is coupled to light guide 22 and gamma ray scintillator 18. Optical detector 26 can be coupled to detect scintillation from neutron scintillator 14 and gamma ray scintillator 18. Also, the apparatus can optionally be covered by moderator 38, which can be a material that thermalizes fast neutrons. Detector 26 can be coupled through preamplifier 30 to a controller 70 which can provide data acquisition, control, display and output. Controller 70 can be easily adapted from electronic controllers known to the art for handheld radiation detection instrumentation, for example, the acquisition, control and display system in a commercial X-ray fluorescent unit (Xli, Niton LLC, Billerica, Mass.). Typically, apparatus 10 is adapted to be handheld, e.g., all components can be included in a single compact unit having a total mass less than about 2.5 kg, or more typically, less than about 1.5 kg.

As described herein, a gamma ray detector can be any gamma ray detector known to the art, for example, a solid state semiconductor detector, or gamma ray scintillator (e.g., 18) in combination with an optical detector (e.g., 26). Typically, the gamma ray detector includes a gamma ray scintillator. Of the disclosed embodiments where a gamma ray scintillator is described, other embodiments are contemplated where the gamma ray scintillator is replaced with a solid state gamma ray detector.

Neutron scintillator 14 can include a material that scintillates in response to fast neutrons, thermal neutrons, or a combination of materials that respond to both types of neutrons. As used herein, thermal neutrons are neutrons that have kinetic energy on the order of kT, where k is Boltzman's constant and T is temperature in Kelvin; fast neutrons are neutrons with kinetic energy greater that kT, typically much greater, e.g., in the range of thousands to millions of electron volts. Typically, the material of neutron scintillator 14 can have excellent efficiency for detecting thermal neutrons and negligible efficiency for detecting X-rays or gamma rays. This material can include a thermal neutron-capturing isotope coupled to a scintillation component that scintillates upon exposure of the capturing isotope to thermal neutrons. The capturing isotope can be any thermal neutron capturing isotope known to the art, for example, ⁶Li, ¹⁰B, ¹¹³Cd, ¹⁵⁷Gd, and the like, generally ⁶Li or ¹⁰B, or more typically ⁶Li. The scintillation component can be any component known to to the art to scintillation in response to the reaction products of thermal neutron capture by a capturing isotope, for example, the scintillation component can be ZnS. The material of neutron scintillator 14 can be any combination of capturing isotope and scintillation component, for example, a compound including at least one of ⁶Li, ¹⁰B, ¹¹³Cd, or ¹⁵⁷Gd combined with ZnS. Typically, the neutron scintillator is a combination of ⁶LiF and ZnS. For example, in various embodiments, neutron scintillator 14 is a commercially available screen material (Applied Scintillation Technologies, Harlow, United Kingdom), approximately 0.5 mm thick made from a mixture of LiF and ZnS. The lithium is isotopically enriched ⁶Li, an isotope with a cross section of 940 barns for capturing a thermal neutron and immediately breaking up into a helium nucleus ⁴He and a triton ³H, with a total energy release of 4.78 MeV. The energetic alphas and tritons can lose energy in the ZnS causing it to scintillate with the emission of about 50 optical photons for every kilovolt of energy lost as the alphas and tritons come to rest. There can thus be a high probability that each captured neutron produces hundreds of thousands of optical light quanta.

Tests of ⁶LiF/ZnS screens have determined that they are selective for thermal neutrons over other radiation, e.g. gamma rays, X-rays, and the like, e.g., these screens have intrinsic efficiencies of about 50% for detecting thermal neutrons, while their efficiency for detecting gamma rays can be negligible, e.g. less than about 10⁻⁸. Selectivity for thermal neutrons versus gamma rays can reduce the rate of “false alarms” due to relatively common gamma ray sources (medical isotopes, radioactive sources in industrial testing equipment, and the like) in favor of valid alarms due to neutron emitters associated with weapons of mass destruction. This selectivity for detection of thermal neutrons versus gamma rays can be expressed as a ratio. In typical configurations, the thermal neutron to gamma ray selectivity is at least about 10,000:1, more typically at least about 1,000,000:1, and in some embodiments, at least about 10,000,000:1.

Optional neutron moderator 38 can be made of a material that thermalizes fast neutrons. One skilled in the art will know of many suitable moderator materials and can select a moderator material, thickness, and location to maximize neutron detection efficiency while minimizing any loss in efficiency for detecting gamma rays. For example, typical neutron moderators are hydrogenous materials such as water, organic solvents (alcohols, ethers (e.g., diethyl ether, tetrahydrofuran), ketones (e.g., acetone, methyl ethyl ketone), alkanes (e.g., hexane, decane), acetonitrile, N,N′ dimethylformamide, dimethyl sulfoxide, benzene, toluene, xylenes, and the like) oils and waxes (e.g., mineral oil, paraffin, and the like), organic polymers (e.g., polyalkanes (e.g., polyethylene, polypropylene, and the like), polyesters, polyvinylenes (e.g., polyvinylchloride) polyacrylates (e.g., polymethymethacrylate), polystyrenes, polyalkylsiloxanes (e.g., poly dimethyl siloxane), and the like), composites or gels of water or organic solvents with polymers (e.g., water gels of gelatin, polyacrylic acid, hyaluronic acid, and the like), and many other such moderators known to the art.

For example, in some embodiments, moderator 38 can be made of an organic polymer, e.g., high density polyethylene, and can be placed over the apparatus 10 to moderate (thermalize) incoming fast neutrons, so that they can be efficiently captured by neutron scintillator 14. In other embodiments, moderator 38 can be a container that holds a suitably thick layer of a liquid moderator covering apparatus 10, for example, water, organic solvents, water gels, and the like. In various embodiments, the hydrogen nuclei in the neutron moderator can be enriched in the ²H isotope, i.e., the fraction of ²H in the moderator is above natural abundance level. In some embodiments, at least about 50%, more typically at least about 90%, or preferably at least about 95% of the hydrogen nuclei in the neutron moderator are the ²H isotope.

Light guide 22 can be coupled to neutron scintillator 14 to direct the scintillation to optical detector 26. Light guide 22 can collect scintillation photons from a relatively large scintillation surface area and direct them to the smaller area of the detector 26. This can result in a higher scintillation collection efficiency for a given detector surface area. Although other configurations are possible, the depicted configuration where light guide 22 can beparallel to the surface of scintillator 14 (which can be perpendicular to the detection surface of detector 26) provides a compact structure suitable for a handheld unit.

In addition to guiding scintillation photons to optical detector 26, light guide 22 can optionally serve one or both of the following additional functions.

First the light guide material can act as a moderator or thermalizer of the fast neutrons, thus slowing them to thermal energies so that they can be efficiently captured by neutron scintillator 14. Thus, light guide 22 can include any neutron moderator described above that can meet the transparency criterion, e.g., typically hydrogenous materials such as water, organic solvents, transparent organic polymers (e.g., polyacrylics, polystyrenes, polycarbonates, polyalkylsiloxanes) composites or gels of water or organic solvents with polymers, mineral oil, and the like. Typically, the material of light guide 22 can be a solid, e.g., an organic polymer, generally a polyacrylate, e.g. in some embodiments, polymethyl methacrylate. In various embodiments, the hydrogen nuclei in the material of light guide 22 can be enriched in the ²H isotope, i.e., the fraction of ²H in the moderator is above natural abundance level. In some embodiments, at least about 50%, more typically at least about 90%, or preferably at least about 95% of the hydrogen nuclei in the neutron moderator are the ²H isotope.

Second, the material of the light guide, described in the preceding paragraph, can have a finite efficiency for scintillating in response to fast neutrons, for example, when fast neutrons strike a hydrogen nuclei, the hydrogen nuclei can be scattered with sufficient energy to give an ionizing signal, which can be detected by optical detector 26. In some embodiments, light guide 22 functions as a fast neutron scintillator and thus encompasses neutron scintillator 14. Thus, in various embodiments, apparatus 10 can detect fast neutrons, thermal neutrons, or fast and thermal neutrons depending on the materials and selection of light guide 22 and neutron scintillator 14.

The gamma ray detector 18 can be any of a variety of gamma ray scintillators known to the art, e.g., sodium iodide doped with thallium (Na(Tl), cesium iodide doped with thallium (CsI(Tl)), bismuth germanate (BGO), barium fluoride (BaF₂), lutetium oxyorthosilicate doped with cesium (LSO(Ce)), cadmium tungstate (CWO), yttrium aluminum perovskite doped with cerium (YAP(Ce)), gadolinium silicate doped with cerium (GSO), and the like. For example, NaI(Tl) can be fast, efficient and inexpensive, but can be hygroscopic and is typically sealed against moisture. Non-hygroscopic crystals such as BaF₂, BGO or LSO, and the like, can also be employed. Such materials are typically selected to have good efficiency for detecting gamma rays from dirty bombs; for example, a 662 keV gamma ray from ¹³⁷Cs (often cited as a radiological threat in a dirty bomb) can have more than an 80% absorption efficiency in a 2.5 cm (1 inch) thick crystal of LSO, which can produce about 10,000 detectable optical photons. Generally, the gamma ray scintillator includes one of NaI(Tl), CsI(Tl), BGO, BaF₂, LSO, or CdWO₄, or more typically, BGO, BaF₂, or LSO. In some embodiments, the gamma ray scintillator is BaF₂, and in other embodiments, the gamma ray scintillator is LSO.

In various embodiments, gamma-ray scintillator 18 and the light guide 22 are transparent to the optical wavelengths generated by any of the scintillation events. As used herein, the terms “transparent” and “transparency” refer to the transmittance per unit path length in a material of light, e.g., scintillation light. Typically, a material transparent to scintillation light transmits, per meter of material, at least about 90%, generally about 95%, and more typically about 98% of scintillation. Typically, the scintillation transmitted is in a range from about 400 nanometers (nm) to about 600 nm, generally from about 350 to about 600 nm, or more typically from about 300 to about 600 nm. Thus, in some embodiments, transparent materials (e.g., the light guides, the gamma ray scintillator, and the like) transmit about 95%/meter of scintillation between about 350 nm and about 600 nm, or more typically, transmit about 98% of scintillation between about 300 nm and about 600 nm.

In various embodiments, the respective refractive indices of the scintillator 18 and the light guide 22 can be in the same range, e.g., between about 1.4 to about 2.4, or more typically, between about 1.5 to about 1.8, and can generally be selected to be similar to minimize reflections at the interface between scintillator 18 and light guide 22.

Thus, in various embodiments, light guide 22 and/or gamma ray scintillator 18 are transparent to scintillation, which can benefit the efficiency of detection at optical detector 26. Further, it can allow the use of a single optical detector 26 because the light from multiple scintillation sources can be collected and delivered on the optical face of detector 26. For example, as depicted in FIG. 1, scintillation from thermal neutrons interacting with neutron scintillator 14 can travel through light guide 22 and gamma ray scintillator 18 to detector 26. In embodiments where light guide 22 can also function as a fast neutron scintillator, its scintillation can also travel through gamma ray scintillator 18 to detector 26, and thus scintillation from three sources (fast neutrons in light guide 22, slow neutrons in scintillator 14, and gamma rays in scintillator 18) can be detected by a single optical detector 26. Further, in some embodiments, alternate arrangements of these components can be possible, for example, the order of light guide 22 and gamma ray scintillator 18 can be reversed and gamma ray scintillation can travel from scintillator 18 through light guide 22 to detector 26.

In various embodiments, where two or more types of scintillation are detected at detector 26, they can be distinguished according to their temporal characteristics, i.e., as a function of time. For example, in embodiments of apparatus 10 equipped to detect fast neutrons, thermal neutrons, and gamma rays, controller 70 can be programmed to sort detected signals according to features of their temporal characteristics, e.g., rise times, decay times, and the like. For example, in some embodiments, employing polymethyl methacrylate for light guide 22 gives a fast neutron scintillation decay time of about 2 nanoseconds; employing LSO for scintillator 18 gives a gamma ray scintillation decay time of about 40 nanoseconds (20 times slower); and employing the ⁶LiF/ZnS in scintillator 14 gives a thermal neutron scintillation decay time of about 30 microseconds (about 15000 times slower than fast neutron scintillation decay and about 700 times slower than gamma ray scintillation decay). Standard rise-time detection circuits known to the art can easily distinguish such temporally separated signals, and thus multiple scintillation types can be sorted, typically unambiguously, by controller 70, to yield separate data, e.g., pulse height spectra for each scintillation type. Standard circuits known to the art can be employed by controller 70 which can be fast enough so that substantially all signals from multiple scintillation sources can be processed.

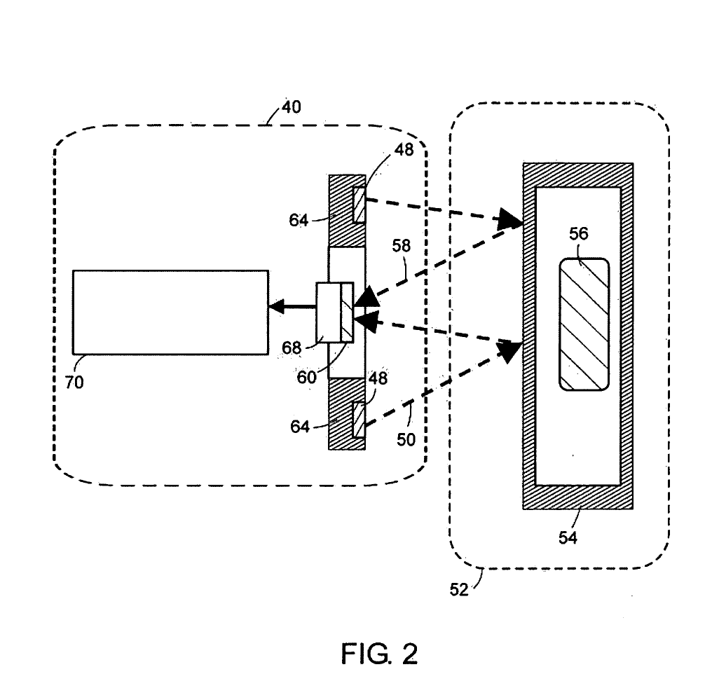

FIG. 2 depicts optional X-ray fluorescence (XRF) detector 40 coupled to controller 70 for detecting high atomic weight (high Z) materials 54 that can shield radioactive materials, e.g. gamma ray source 56.

The XRF analyzer 40 can be easily adapted from commercial XRF detectors known to the art, for example, the Xli XRF analyzer, Niton LLC, Billerica, Mass. The XLi is a hand-held unit weighing less than 1 kg (2 pounds) that contains radioactive fluorescing sources, for example, it can contain a strong source of ⁵⁷Co, which emits a 122 keV gamma ray that can excite the characteristic x-ray of various high-Z, heavy elements, including tungsten, lead, uranium, plutonium, and the like. Emitted X-ray fluorescence radiation can be detected in a detector, e.g., a cooled CdTe detector, which can have excellent efficiency and resolution for detecting the characteristic X-rays of high-Z materials. The processed information can be displayed, e.g., in a liquid crystal display. The collected information, including the pulse height spectra, can be stored in unit 70, can be telemetered to a remote location, and can automatically alert the operator to a potential hazard.

Thus, XRF analyzer 40 can optionally include a radioactive source 48 (typically encased in shield 64) to stimulate X-ray fluorescence in target materials, e.g., shield material 54 surrounding radioactive source 56 in bomb 52. For example, in one embodiment radioactive source 48 (depicted in FIG. 2 as optional dual sources) can be ⁵⁷Co, which can emit 122 keV gamma rays in about 90% of its decays. The 122 keV gamma rays can be efficient exciters of the K X-rays of high atomic weight/high Z material 54 that can be suitable as shielding for radioactive source 56, for example, high Z materials such as tungsten, lead, uranium, plutonium, and the like. XRF analyzer 40 includes a detector 60, which can be any X-ray detector known to the art, for example in various embodiments detector 60 can be a CdTe (cadmium telluride) semiconductor detector, about 2 mm thick, coupled to a preamplifier 68. A 2 mm thick CdTe detector can have an intrinsic efficiency of more than about 80% for detecting the K rays of high atomic weight/high Z elements. The energy resolution of commercially available CdTe detectors can be greater than about 2 keV for 100 keV gamma rays, which can be sufficient to separate the K X-rays of various heavy elements and identify, at least in part, the elemental composition of the shielding material 54. One skilled in the art can determine that for some embodiments, a commercially available 100 mCi ring source of ⁵⁷Co, together with a 1 cm², CdTe detector 2 mm thick, can determine the presence of a lead shield inside a container of steel up to 6.4 mm (¼ inch) thick, at a distance of one foot from the detector.

Each possible radiation detection combination is contemplated in various embodiments of the method and apparatus. For example, included in various embodiments are XRF and fast neutron detection; XRF and thermal neutron detection; XRF and gamma ray detection; XRF, fast neutron, and gamma ray detection; XRF, thermal neutron, and gamma ray detection; XRF, fast neutron, thermal neutron, and gamma ray detection; fast neutron and gamma ray detection; thermal neutron and gamma ray detection; fast neutron and thermal neutron detection; fast neutron, thermal neutron, and gamma ray detection; and the like. Further, each of these are contemplated in various embodiments as automatically controlled, e.g., by a single controller 70, and adapted for handheld operation, e.g., in a single handheld unit.

In other embodiments, one or more detectors can be coupled with controller 70 by an umbilical cord or a wireless communication link, and the like. For example, a single handheld apparatus can include a controller and an XRF analyzer combined with a gamma/neutron detector subunit; the subunit can be detached from the main unit containing the controller and the XRF unit, and can communicate with the controller via an umbilical cord or a wireless communication link. This can allow for more flexible detection usage, for example, a detachable gamma/neutron probe can be employed to search difficult to reach areas in vehicles or confined spaces.

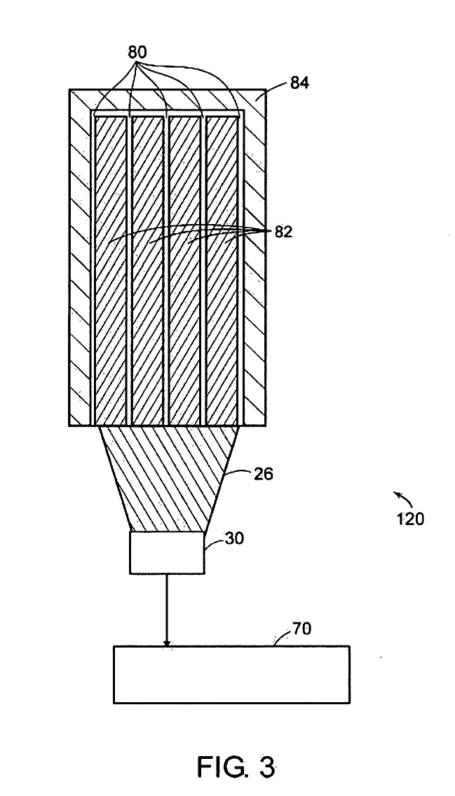

FIG. 3 depicts an embodiment of new neutron detector apparatus 120 employing a configuration of light guides 82 and thermal neutron scintillator layers 80. Apparatus 120 can be employed as a neutron detector, optionally in combination with the other features as depicted for apparatus 10 in FIG. 1. The new detector interleaves layers or sheets of thermal-neutron capturing scintillator material 80 with light guide plates 82 of optically transparent, light-element, preferably hydrogenous, material.

Light guide plates 82 can be coupled to neutron scintillator 80 to direct the scintillation to optical detector 26. Light guides 82 can function to collect scintillation photons from a relatively large scintillation surface area provided by the multiple layers of scintillator 80 and direct them to the smaller area of the detector 26. This can result in a higher scintillation collection efficiency for a given detector surface area. Although other configurations are possible, the depicted configuration where light guides 82 are parallel to the surface of scintillator layers 80 (which can be perpendicular to the detection surface of detector 26) provides a compact structure suitable for a handheld unit.

Light guides 82 can have two independent functions: they thermalize (moderate) fast neutrons so that they are captured by the thermal-neutron detector scintillator 80 producing optical light, and they can direct the scintillation light to optical detector 26. A preferred embodiment uses a thermal-neutron scintillator 80 as a scintillation detecting screen, approximately 0.5 mm thick made from ⁶LiF:ZnS. Commerically available (Applied Scintillation Technologies, Harlow, United Kingdom) scintillation material 0.5 mm thick can have about a 50% capture probability for thermal neutrons. Light guides 82 can be any optically transparent material that is also a good moderator of fast neutrons, for example acrylic plastic, e.g., polymethyl methacrylate.

Light guides 82 can also be any transparent plastic scintillator, for example, optically transparent sheets of plastic doped with various compounds known to the art to scintillate in response to thermal neutrons, fast neutrons, and/or other radiation of interest). Typical scintillators are themselves well-known detectors of fast neutrons and can serve the triple roles as instrinsic fast neutron scintillators, as neutron moderators, and as light guides to optical detector 26. Additionally, light guides 82 can be water, H₂O, or even heavy water, D₂O, in which the hydrogen can be replaced with the ²H isotope of hydrogen. Water can be an especially effective neutron moderator, and heavy water has a very small probability of absorbing neutrons. Still other materials known to the art which can be employed for light guides 82 are liquid scintillators, which can also be good neutron moderators and can scintillate in response to fast neutrons and distinguish that scintillation from gamma ray scintillation. Thermal-neutron scintillator 80 can typically be coupled to polymethyl methacrylate light guides 82 with, for example, an optically transparent layer of silicon, epoxy, and/or a liquid coupling agent in direct contact with the screens. An optional neutron moderator 84, which can be optically opaque, e.g., high density polyethylene, can be employed to increase the efficiency of neutron detection.

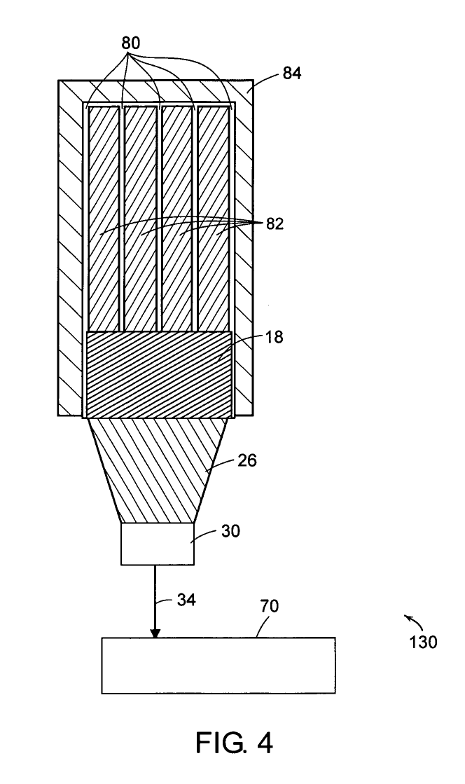

FIG. 4 depicts the components of an apparatus 130 for selective detection of neutrons and gamma rays viewed by a single optical detector 26. In applications in which gamma ray and neutrons are desired to be detected separately, a gamma ray scintillation detector 18 can be attached to one end of the light guides/scintillators 80/82. The signals from the gamma ray detector and neutron detector are separated by their different temporal characteristics as described above. If the portion of apparatus 130 defined by light guides/scintillators 80/82 is long, for example, more than about 30 cm in length, it may be advantageous to put an optical detector on both ends of the combined gamma ray and neutron detector. The signals from two optical detectors can be added and the combined signal can be separately analyzed into neutron and gamma ray signals according to temporal characteristics as described above.

Further embodiments of the apparatus 130 can be useful for applications in which it is desired to detect fast neutrons. In some embodiments, the neutron scintillators 82 can be made out of a material, e.g., organic polymer, that scintillates in response to fast neutrons. In other embodiments, the ⁶LiF:ZnS neutron scintillator material can be suspended in a liquid scintillator, e.g., water, organic solvents, mineral oil, and the like, wherein the decay time of scintillation light emitted when a gamma ray or electron is detected can be significantly different from the decay time of scintillation light emitted when a fast proton (e.g., due to fast neutron scintillation) is detected. Since the two decay time constants of the liquid scintillator differ significantly from the decay time constants of the gamma ray detector 18 or light guides/scintillators 80/82, it can be possible to separate all four signals and therefore completely discriminate fast neutrons, thermal neutrons, and gamma rays using a single optical detector (or one or more optical detectors, the outputs of which are added together).

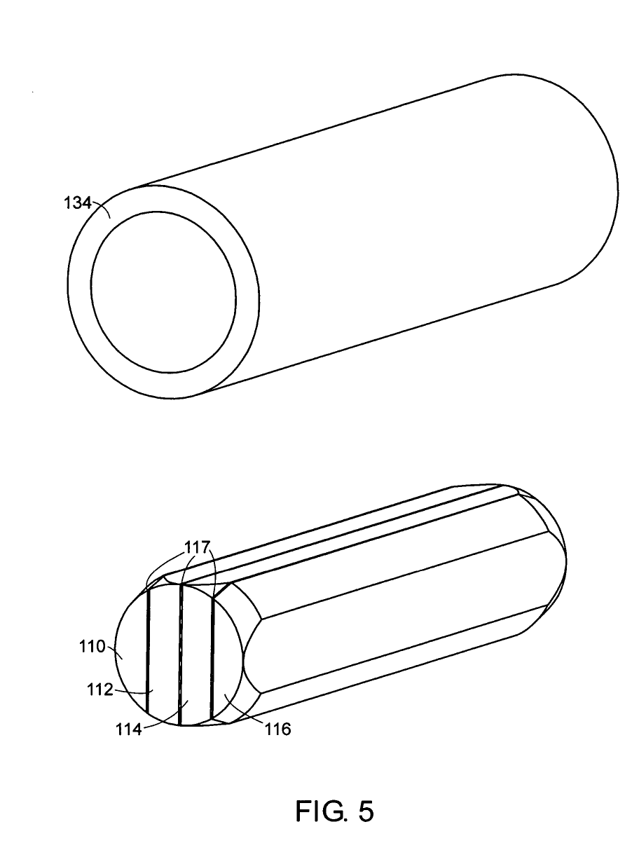

FIG. 5 depicts an isometric drawing of an embodiment of a new neutron scintillator/light guide apparatus 150. Four sheets, 110, 112, 114 and 116 of optically transparent polymethyl methacrylate, about 5.1 cm wide by about 30.5 cm long by about 1.25 cm thick, polished on all sides, have thermal neutron scintillator material ⁶LiF:ZnS 116 layered between each 5.1 cm×30.5 cm side and on the top and bottom. The four slabs with their Li6F: ZnS screens make a multilayer sandwich, 150, 5.1 cm×30.5 cm by about 5.6 cm high. Apparatus 150 can be coupled to an optical detector, for example, apparatus 150 can replace neutron scintillators/light guides 80/82 in FIG. 4. As above, for applications that require very long detectors and/or detection of faint signals, it can be useful to attach a second optical detector, e.g., a photomultiplier tube, to each end of such a light guide/scintillator apparatus so as to increase the amount of light detected by employing two detectors.

Monte Carlo simulations, confirmed by experiment, show that polymethyl methacrylate can be about 75% as effective as high-density polyethylene for thermalizing neutrons. Thus, the neutron scintillator/light guide 150 can be an efficient neutron detector as shown. It can be made about 30% more effective by covering the length of the detector with a layer of neutron moderator 134, e.g., high density polyethylene, and still more effective by placing a layer of neutron-scintillator material between the light guide/scintillator 150 and the neutron moderator 134.

The neutron selectivity over gamma rays of light guide/scintillator 150 was measured at of 5×10⁸:1. Commercial ³He gas proportional counters, the current “gold standard” of neutron detectors, have rejection ratios ranging from 10³ to 10⁶. Thus, the detector can have a gamma ray rejection ratio that is more than 1000 times greater than the best current commercial ³He detectors.

As noted above, selectivity for neutrons over gamma rays can be essential for detecting neutron sources, e.g., plutonium, while minimizing false alarms from gamma ray sources. For example, one current security standard desires a neutron detector to detect the presence of 0.455 kg (1 pound) of plutonium at a distance of 2 meters. 0.455 kg (1 pound) of plutonium emits approximately 20,000 fast neutrons per second. At 2 meters, there are at most 0.04 neutrons crossing per cm of the detector per second. If the efficiency for detecting the neutron is 50%, which can be attained for light guide/scintillator 150, then the count rate is only 0.02/sec/cm². If the efficiency of the neutron detector for detecting gamma rays is 10⁻³, then 20 gamma rays/sec/cm², from a modest source, will give the same signal as the neutrons from 0.455 kg (1 pound) of plutonium, and trigger an alert. Neutron light guide/scintillator 150, with an efficiency for detecting gamma rays of only 2×10⁻⁹, will typically not be alerted by modest gamma ray sources compared to the preceding security standard for neutron emission from plutonium. In fact, neutron light guide/scintillator 150, will typically not detect a gamma ray source as equivalent to the neutron/plutonium security standard unless the gamma ray source is itself a serious health risk.

The light guide/scintillator 150 has other practical advantages over conventional ³He detectors. Commercial ³He detectors typically have only about 10% efficiency for detecting neutrons unless surrounded by a thick neutron moderator such as a 5.1 cm thick cover of high density polyethylene. The disclosed neutron detectors, with intrinsic neutron moderation provided by the light guide, e.g., the polymethyl methacrylate light guides 110, 112, 114 and 116 in neutron light guide/scintillator 150, can have an efficiency of almost 40% without a high density polyethylene cover. Further, if necessary to achieve the efficiency of a fully moderated ³He detector, the disclosed neutron detectors can employ a much thinner moderator (e.g., polyethylene) to obtain full moderation. Thus, the detectors disclosed herein can be significantly lighter than a commercial ³He detector of the same efficiency, which is of central importance for adapting a device to handheld use.

Also, light guide/scintillator 150 can be very robust and can be free of travel restrictions. A ³He detector contains the isotope ³He at a pressure typically from about two to about four atmospheres. In many situations, transportation regulations require special procedures for transporting such detectors.

Also, commercial ³He detector are limited to an operating temperature range from +10° C. to +50° C., where detection can still be affected by changes in temperature. Light guide/scintillator 150 can be insensitive to temperature change over a range of at least about −10° C. to about 50° C.

Still another advantage is that the disclosed detector, in sizes large enough to meet Homeland Security requirements, can be less costly than commercial ³He detectors of comparable efficiency because the cost of comparable materials, e.g., the light guide material, are typically much less expensive compared to the cost of ³He in a conventional detector.

One skilled in the art will appreciated that many possible arrangements of one or more light guides and one or more neutron scintillation layers can be combined with an optical detector to form a neutron detector, for example, a neutron scintillation layer can be applied to the front of a block of light guide material, and an optical detector can be coupled to the back of the block of light guide material. However, arrangements of multiple layers of light guides and neutron scintillators in combination with one or more optical detectors as provided in FIGS. 3-5 are particularly effective as described above.

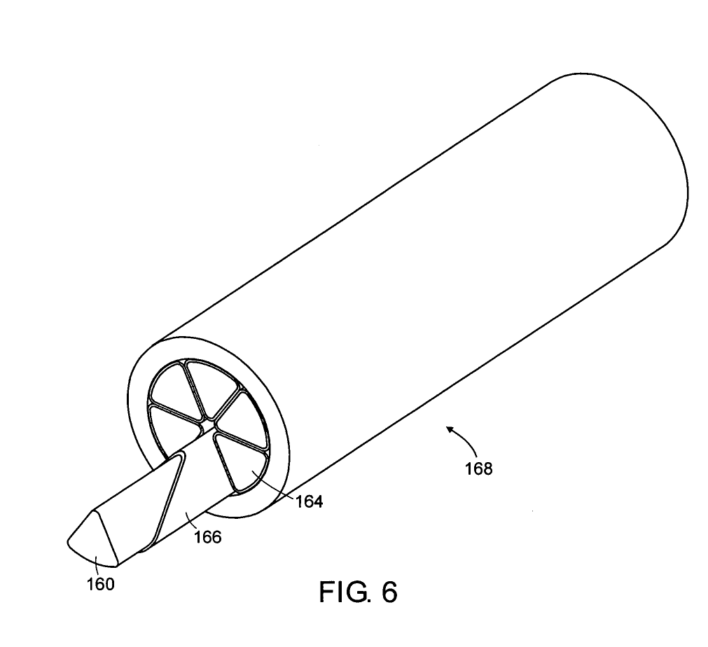

FIG. 6 depicts another embodiment of neutron scintillator/light guide apparatus 168 where multiple light guide segments 160 are employed to provide the neutron detector with directional capability. Light guide segments 160 are arranged in the form of a hexagon 164 segmented into six pie-like sections. The ⁶LiF:ZnS thermal neutron scintillator material 166 can be applied to surround each light guide segment 160. Scintillation light collected from each segment, whether from fast neutron scintillation in the light guide material, thermal neutron scintillation in material 166, or both, can be detected separately, for example by employing a segmented optical detector, which is commercially available, or with separate optical detectors. The light collected at the different segments can be correlated with the direction of a neutron source, e.g., by appropriate modeling or by conducting calibration experiments. One skilled in the art will appreciate that the hexagonal segmentation shown in FIG. 6 is one of many configurations that can allow differential detection of scintillation based on the direction of the neutron source compared to the detector; for example, the arrangement of neutron scintillator material 80 and light guides 82 in FIG. 4 or 5 can have the same function.

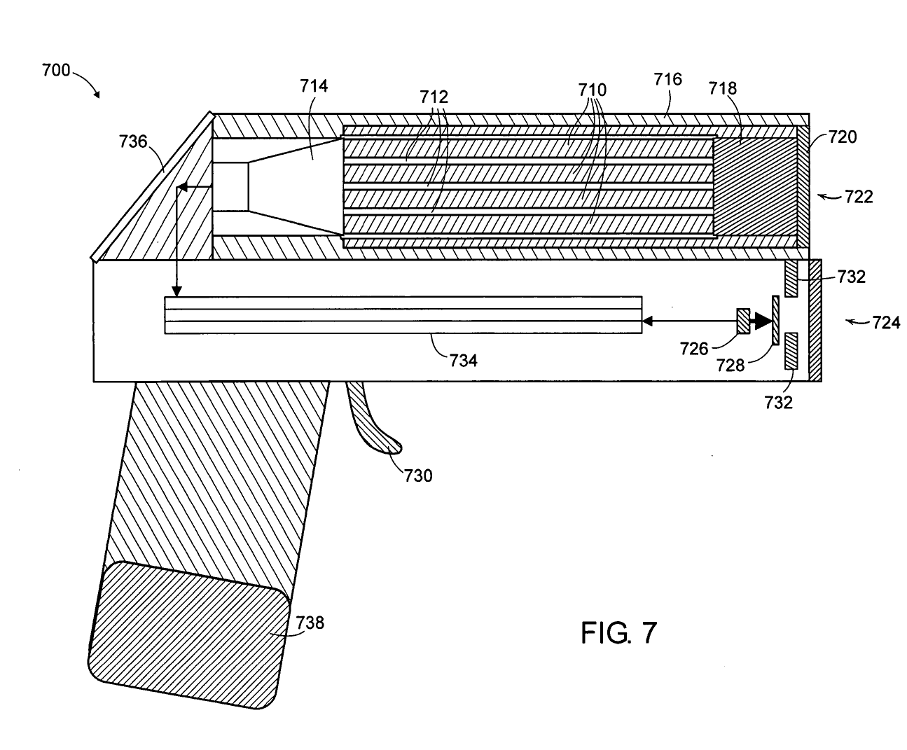

FIG. 7 depicts apparatus 700 in which neutron and gamma detectors and an -ray fluorescent analyzer are integrated with a controller into a single, compact unit adapted for handheld Homeland Security bomb detection. Apparatus 700 which has been designed through experimental test and Monte Carlo computer simulation. Apparatus 700 includes a selective neutron detector that is insensitive to gamma rays; a selective gamma ray detector that is insensitive to neutrons; and an XRF detector capable of finding shielding material at least about 30.5 cm (12 inches) inside a box made of 3.1 mm (⅛ inch) steel.

The neutron detector, with overall dimensions of 5.1 cm by 5,1 cm by 25.4 cm, consists of 4 sheets of polished, transparent polymethyl methacrylate light guides 710, each 1.25 cm by 5.1 cm by 25.4 cm, with 0.43 mm thick ⁶LiF/ZnS neutron scintillators 712 covering all faces of guides 710 but the ends that are abutting the face of a 5.1 cm optical detector 714, which is a photomultiplier. The outside of the detector is covered by a neutron moderator 716 of 1.25 cm thick high-density polyethylene, which, together with the polymethyl methacrylate light guides 710, moderate incoming fast neutrons so that they are efficiently captured by ⁶LiF/ZnS neutron scintillators 712. Gamma-ray scintillator 718 is a 5.1 cm diameter, 5.1 cm long single crystal of BaF₂, which can have a good efficiency for detecting gamma rays and a good energy resolution for identifying the emitting isotope. A thin window 720 of, for example, aluminum or plastic about 0.8 mm thick, in front of gamma-ray scintillator 718 and parallel to optical detector 714 can adapt the gamma detector to be sensitive to gamma radiation from 50 keV to several MeV. One skilled in the art will know how to select windows of other materials or thicknesses to adapt the gamma detector to other radiation ranges. In the depicted embodiment, scintillator 718 is located opposite detector 714 from guide/scintillators 710/712. (In other embodiments, higher energy resolution of the BaF₂ gamma scintillator 718 can be obtained by placing scintillator 718 between detector 714 and guide/scintillators 710/712. A thin layer of, of, for example, aluminum or plastic about 0.8 mm thick, can be placed as a band around the BaF₂ gamma scintillator 718, perpendicular to the face of detector 714.) The scintillation light from the BaF₂ is transmitted through light guides 710 to detector 714.

The signals from the BaF₂ gamma scintillator 718 are separated from those from the ⁶LiF/ZnS neutron scintillators 712 by their different decay times of 0.63 microseconds and ˜30 microseconds, respectively.

The neutron/gamma assembly 722 is fitted as the top of a modified model XLp XRF analyzer 724 (Niton, ibid), which employs digitized pulse processing to analyze two detector 714 and XRF detector 726 simultaneously, storing the spectra and results of 4,096 channels data, all of which can be telemetered wirelessly to central command points.

XRF analyzer 724 uses a 100 mCi, well-shielded, ⁵⁷Co source 726 that emits, when shutter 728 is opened by trigger 730, 122 keV gamma rays for exciting the characteristic X-rays of heavy-element shielding; the characteristic X-rays are detected in large-area CdTe detectors 732. The size of apparatus 700 is similar to that of a large cordless drill, with a weight of about 3 kg, including a battery power supply. A full battery charge can give up to 12 hours of continuous operation or more.

Controller 734 operates the detectors of apparatus 700 and displays radiation detection results on display screen 736. A portable power source 738, e.g., a battery or fuel cell, can be included.

In various embodiments each detector/analyzer can operate separately from each other or the controller via a modular design. For example, the neutron/gamma-ray detectors can be a detachable module from a base unit including the XRF analyzer and the controller, and the /gamma-ray detectors can communicate with the controller via an umbilical cord, wireless communication, and the like. Thus, the /gamma-ray detectors can be an entirely independent module or preferably can dock with the balance of apparatus 700. One skilled in the art can provide for such remote operation, for example, in the case of umbilical cord operation, employing suitable preamplifier circuitry or in the case of wireless operation, coupling off-the-shelf wireless communication modules with the controller and the XRF detector.

Government agencies can establish desired detection specifications, for example, for antiterrorism purposes, environmental monitoring, and the like. Various embodiments can meet one or more of the following specifications, including, for example:
1. Detect in 10 seconds, at a distance of 2 meters, an unshielded neutron source that emits 20,000 or more neutrons per second;
2. Detect in 10 seconds, at a distance of 2 meters, an unshielded, 10 μCi ¹³⁷Cs source;
3. Identify a specific radioisotope based on emitted gamma rays; and
4. Detect high Z shielding up to 1 foot (30.5 cm) from the detector and behind as much as ¼″ (6.4 mm) of steel or material with equivalent absorption.

While this invention has been particularly shown and described with references to preferred embodiments thereof, it will be understood by those skilled in the art that various changes in form and details may be made therein without departing from the scope of the invention encompassed by the appended claims.

1. An apparatus for selective radiation detection, comprising:
a neutron scintillator;
an optical detector; and
a light guide that couples the neutron scintillator to the optical detector, wherein the light guide is solid or liquid.

2. The apparatus of claim 1, wherein the apparatus is adapted to be handheld.

3. The apparatus of claim 1, wherein the neutron scintillator selectively responds to thermal neutrons over gamma rays by a factor of at least about 10,000:1.

4. The apparatus of claim 1, wherein the apparatus selectively responds to thermal neutrons over gamma rays by a factor of at least about 1,000,000:1.

5. The apparatus of claim 1, further comprising a plurality of light guides.

6. The apparatus of claim 1, further comprising a plurality of neutron scintillators.

7. The apparatus of claim 1, wherein the neutron scintillator responds to fast neutrons.

8. The apparatus of claim 1, wherein the neutron scintillator responds to thermal neutrons.

9. The apparatus of claim 8, wherein the neutron scintillator comprises a thermal neutron capturing isotope coupled to a scintillation component that scintillates upon exposure of the capturing isotope to thermal neutrons.

10. The apparatus of claim 9, wherein the capturing isotope is selected from ⁶Li, ¹⁰B, ¹¹³Cd, and ¹⁵⁷Gd.

11. The apparatus of claim 9, wherein the scintillation component is ZnS.

12. The apparatus of claim 9, wherein the neutron scintillator comprises ⁶LiF and ZnS.

13. The apparatus of claim 7, wherein the light guide has a refractive index from about 1.4 to about 2.4.

14. The apparatus of claim 13, wherein the light guide comprises a hydrogenous material that thermalizes fast neutrons.

15. The apparatus of claim 13, wherein the light guide includes at least one material selected from water, organic solvents, mineral oil, and organic polymers.

16. The apparatus of claim 13, wherein the light guide is polymethyl methacrylate.

17. The apparatus of claim 14, wherein the hydrogen nuclei in the light guide are enriched in the ²H isotope of hydrogen.

18. The apparatus of claim 1, wherein the apparatus is covered at least in part by a material that thermalizes fast neutrons.

19. The apparatus of claim 18, wherein the apparatus is covered at least in part by a material selected from water, organic solvents, mineral oil, and organic polymers.

20. The apparatus of claim 19, wherein the hydrogen nuclei in the light guide are enriched in the ²H isotope of hydrogen.

21. The apparatus of claim 1, wherein the apparatus is covered at least in part by high density polyethylene.

22. The apparatus of claim 8, further comprising a controller coupled to the optical detector.

23. The apparatus of claim 22, further comprising a display coupled to the controller to display radiation detection results.

24. The apparatus of claim 22, wherein the light guide includes a fast neutron scintillator, the controller detecting temporal characteristics of scintillation to distinguish scintillation corresponding to fast neutrons from scintillation corresponding to thermal neutrons.

25. The apparatus of claim 22, further including a plurality of neutron scintillators and a plurality of light guides, wherein the major surfaces of the neutron scintillators are substantially aligned with the optical axis of the optical detector.

26. The apparatus of claim 25, wherein the light guides are planar sheets of polymethyl methacrylate.

27. The apparatus of claim 25, wherein the controller independently detects a scintillation signal at the optical detector from each of at least two light guides, and correlates the relative strength of the scintillation signals with the direction of a neutron source incident on the apparatus.

28. The apparatus of claim 8, further comprising a gamma ray scintillator coupled to the optical detector.

29. The apparatus of claim 28, wherein the gamma ray scintillator has a refractive index from about 1.4 to about 2.4.

30. The apparatus of claim 28, wherein the gamma ray scintillator has a transparency of at least about 95% per meter for light from about 300 nm to about 600 nm.

31. The apparatus of claim 28, wherein the gamma ray scintillator comprises a material selected from NaI(Tl), CsI(Tl), BGO, BaF₂, LSO, and CdWO₄.

32. The apparatus of claim 28, wherein the gamma ray scintillator is BaF₂.

33. The apparatus of claim 28, further comprising a controller that is coupled to the optical detector to selectively detect neutrons and gamma rays.

34. The apparatus of claim 33, wherein the controller selectively detects neutrons and gamma rays by the temporal characteristics of their scintillation signals.

35. The apparatus of claim 28, further comprising an X-ray fluorescence analyzer.

36. The apparatus of claim 35, wherein the X-ray fluorescence analyzer is adapted for independent operation by umbilical cord or wireless communication.

37. The apparatus of claim 35, further comprising a controller that:
is coupled to the optical detector to selectively detect neutrons and gamma rays; and
is coupled to the X-ray fluorescence analyzer to detect X-ray fluorescence.

38. The apparatus of claim 37, wherein the controller is coupled to the X-ray fluorescence analyzer to irradiate a target with X-rays and selectively detect X-ray fluorescence from the target.

39. The apparatus of claim 1, further comprising an X-ray fluorescence analyzer.

40. The apparatus of claim 39, wherein the X-ray fluorescence analyzer is adapted for independent operation by umbilical cord or wireless communication.

41. The apparatus of claim 39, further comprising a controller that is coupled to the optical detector to selectively detect neutrons.

42. The apparatus of claim 41, wherein the controller is coupled to the X-ray fluorescence analyzer to irradiate a target with X-rays and selectively detect X-ray fluorescence from the target.

43. The apparatus of claim 8, further comprising a solid state gamma ray detector.

44. An apparatus for selective radiation detection, comprising:
an X-ray fluorescence analyzer; and
a gamma ray scintillator coupled to at least one optical detector.

45. The apparatus of claim 44, wherein the X-ray fluorescence analyzer is adapted for independent operation by umbilical cord or wireless communication.

46. The apparatus of claim 44, wherein the gamma ray scintillator is BaF₂.

47. The apparatus of claim 46, further comprising a controller that:
is coupled to the optical detector to selectively detect gamma rays; and
is coupled to the X-ray fluorescence analyzer to irradiate a target with X-rays and selectively detect X-ray fluorescence from the target.

48. The apparatus of claim 46, wherein the apparatus is adapted to be handheld.

49. An apparatus for selective radiation detection, comprising:
an X-ray fluorescence analyzer; and
a neutron scintillator coupled to an optical detector.

50. The apparatus of claim 49, wherein the X-ray fluorescence analyzer is adapted for independent operation by umbilical cord or wireless communication.

51. The apparatus of claim 49, further comprising a controller that:
is coupled to the optical detector to selectively detect fast and thermal neutrons by scintillation as a function of time;
is coupled to the X-ray fluorescence analyzer to irradiate a target with X-rays and selectively detect X-ray fluorescence from the target; and
is coupled to a display for displaying radiation detection results.

52. The apparatus of claim 50, wherein the apparatus is adapted to be handheld.

53. An apparatus for selective radiation detection, comprising a gamma ray detector and a neutron scintillator coupled to an optical detector.

54. The apparatus of claim 53, wherein the gamma ray detector is a gamma scintillation detector coupled to the optical detector.

55. The apparatus of claim 54, further comprising a controller that is coupled to the optical detector to selectively detect neutrons and gamma rays by their temporal characteristics.

56. The apparatus of claim 54, wherein the controller selectively detects fast neutrons, thermal neutrons, and gamma rays by their temporal characteristics.

57. The apparatus of claim 56, further comprising a controller that:
is coupled to an X-ray fluorescence analyzer to irradiate a target with X-rays and selectively detect X-ray fluorescence from the target; and
is coupled to a display for displaying radiation detection results.

58. The apparatus of claim 57, wherein the apparatus is adapted to be handheld.

59. The apparatus of claim 1, further comprising:
a gamma ray scintillator coupled to the optical detector; and
an X-ray fluorescence analyzer.

60. The apparatus of claim 59, wherein the gamma ray scintillator and neutron scintillator coupled to the optical detector are adapted for operation independent from the X-ray fluorescence analyzer by umbilical cord or wireless communication.

61. The apparatus of claim 59, further comprising a controller that:
is coupled to the optical detector to selectively detect fast neutrons, slow neutrons, and gamma rays by the temporal characteristics of their scintillation signals;
is coupled to the X-ray fluorescence analyzer to irradiate a target with X-rays and selectively detect X-ray fluorescence from the target; and
is coupled to a display for displaying radiation detection results.

62. The apparatus of claim 61, wherein the apparatus is adapted to be handheld.

63. An apparatus for selective radiation detection, comprising:
a neutron scintillator that selectively responds to thermal neutrons over gamma rays by a factor of at least about 1,000,000:1;
an optical detector; and
a light guide that couples the neutron scintillator to the optical detector.

64. A handheld apparatus for selective radiation detection, comprising:
a neutron scintillator material that selectively responds to thermal neutrons over gamma rays by a factor of at least about 1,000,000:1;
a gamma ray scintillator;
an optical detector coupled to the neutron scintillator and the gamma ray scintillator;
a plurality of light guides in the form of planar sheets, the sheets being interleaved with the neutron scintillator material to couple neutron scintillation to the optical detector;
an X-ray fluorescence analyzer; and
a controller coupled to the optical detector and the X-ray analyzer.

65. A method for selectively detecting radiation, comprising the steps of:
exposing a neutron scintillator to a source of neutron radiation;
directing scintillation from the neutron scintillator to an optical detector through a light guide;
selectively detecting neutrons compared to gamma rays by a factor of at least about 10,000:1.

66. The method of claim 65, wherein the neutrons are detected in a handheld apparatus.

67. The method of claim 65, further including selectively detecting neutrons compared to gamma rays by a factor of at least about 1,000,000:1.

68. The method of claim 65, further comprising directing the scintillation to the optical detector with a plurality of light guides.

69. The method of claim 65, further comprising exposing a plurality of neutron scintillators to the source of neutron radiation.

70. The method of claim 65, further comprising detecting fast neutrons.

71. The method of claim 65, further comprising detecting thermal neutrons.

72. The method of claim 65, further comprising thermalizing fast neutrons with the light guide, wherein the light guide includes at least one material selected from water, organic solvents, mineral oil, and organic polymers.

73. The method of claim 71, wherein the light guide is polymethyl methacrylate.

74. The method of claim 72, wherein the hydrogen nuclei in the light guide are enriched in the ²H isotope of hydrogen.

75. The method of claim 65, further comprising thermalizing fast neutrons before the neutrons contact the neutron scintillator or the light guide.

76. The method of claim 65, further comprising capturing thermal neutrons with a capturing isotope selected from ⁶Li, ¹⁰B, ¹¹³Cd, and ¹⁵⁷Gd.

77. The method of claim 76, further comprising causing scintillation by contacting the reaction products of the thermal neutrons and the capturing isotope with ZnS.

78. The method of claim 65, further comprising automatically selectively detecting radiation.

79. The method of claim 78, further comprising automatically displaying radiation detection results.

80. The method of claim 78, further comprising automatically distinguishing scintillation corresponding to fast neutrons from scintillation corresponding to thermal neutrons by detecting temporal characteristics of scintillation.

81. The method of claim 78, further comprising automatically determining the direction of a neutron source with respect to the optical detector by comparing scintillation directed from at least two light guides to the optical detector.

82. The method of claim 65, further comprising contacting a gamma ray scintillator selected from NaI(Tl), CsI(Tl), BGO, BaF₂, LSO, and CdWO₄ with gamma rays, directing gamma ray scintillation to the optical detector, and detecting the gamma ray scintillation.

83. The method of claim 82, further comprising automatically selectively detecting neutron and gamma ray scintillation at the optical detector.

84. The method of claim 83, further comprising selectively detecting gamma rays and neutrons by comparing the temporal characteristics of their scintillation signals.

85. The method of claim 84, further comprising automatically irradiating a target with X-rays and selectively detecting X-ray fluorescence from the target for evidence of a radioactive shielding material that includes a high atomic weight element.

86. The method of claim 85, further comprising conducting the X-ray fluorescence analysis independently by umbilical cord or wireless communication.

87. A method for selectively detecting radiation, comprising:
analyzing X-ray fluorescence from a target; and
detecting gamma rays by contacting a gamma ray scintillator with gamma rays and detecting scintillation.

88. The method of claim 87, further comprising automatically irradiating a target with X-rays and selectively detecting X-ray fluorescence from the target.

89. The method of claim 87, further comprising automatically displaying the radiation detection results.

90. The method of claim 87, further comprising conducting the X-ray fluorescence analysis independently by umbilical cord or wireless communication.

91. A method for selectively detecting radiation, comprising:
analyzing X-ray fluorescence from a target; and
detecting neutrons by contacting a neutron scintillator with neutrons and detecting scintillation.

92. The method of claim 91, further comprising automatically irradiating a target with X-rays and selectively detecting X-ray fluorescence from the target.

93. The method of claim 91, further comprising automatically displaying the radiation detection results.

94. The method of claim 91, further comprising automatically detecting scintillation in the neutron scintillator from neutrons, neutrons being selectively detected in the neutron scintillator compared to gamma rays by a ratio of at least about 1,000,000:1.

95. The method of claim 91, further comprising conducting the neutron detection in a separate module that communicates with the controller by umbilical cord or wireless communication.

96. A method for selectively detecting radiation, comprising:
contacting a neutron scintillator with neutrons;
contacting a gamma ray scintillator with gamma rays; and
selectively detecting scintillation from the neutrons and the gamma rays.

97. The method of claim 96, further comprising automatically selectively detecting neutrons and gamma rays by comparing the temporal characteristics of their scintillation.

98. The method of claim 96, further comprising automatically selectively detecting fast neutrons, thermal neutrons, and gamma rays by comparing the temporal characteristics of their scintillation.

99. The method of claim 96, further comprising automatically detecting scintillation in the neutron scintillator from neutrons, neutrons being selectively detected in the neutron scintillator compared to gamma rays by a ratio of at least about 1,000,000:1.

100. A method for selective detection of radioactive weapons of mass destruction or shields thereof, comprising:
exposing a neutron scintillator to a suspected neutron source, and analyzing for scintillation in the neutron scintillator from neutrons, neutrons being selectively detected in the neutron scintillator compared to gamma rays by a ratio of at least about 1,000,000:1;
exposing a gamma ray scintillator to a suspected gamma ray source and analyzing for scintillation in the gamma ray scintillator from gamma rays; and
irradiating a target with X-rays and selectively analyzing X-ray fluorescence from the target for evidence of high atomic weight shielding material.

101. Means for selectively detecting radiation, comprising:
means for exposing a neutron scintillator to a source of neutron radiation;
means for directing scintillation from the neutron scintillator to an optical detector; and
means for selectively detecting neutrons compared to gamma rays by a factor of at least about 10,000:1.

102. Means for selectively detecting radiation, comprising:
means for analyzing X-ray fluorescence from a target; and
means for detecting gamma rays.

103. Means for selectively detecting radiation, comprising:
means for analyzing X-ray fluorescence from a target; and
means for detecting neutrons.

104. Means for selectively detecting radiation, comprising:
means for detecting neutrons; and
means for detecting gamma rays.
